(19) United States
(12) Patent Application Publication
(10) Pub. No.: US 2011/0111800 A1
(43) Pub. Date: May 12, 2011

(54) Cellular Phone Memory Card With Voice Activated Component

(76) Inventor: Temar Harper, Chicago, IL (US)

(21) Appl. No.: 12/944,292

(22) Filed: Nov. 11, 2010

Related U.S. Application Data
(60) Provisional application No. 61/260,015, filed on Nov. 11, 2009.

(51) Int. Cl. H04W 4/00; H04W 88/02

(52) U.S. Cl. 455/556.2; 455/563; 455/559

(57) ABSTRACT

The present invention is a cellular phone card used in combination with a user's and a user's cellular phone. The cellular phone card includes a voice activated component that includes a voice receiver to receive the user's voice commands and instructions and a voice converting unit that receives and converts the user's voice commands and instructions into an electronic signal transmitted over a bus to a processing unit to process and execute the user's voice commands and instructions. There is also memory storage with operating software to store data and run any of the user's voice commands and instructions associated with the cellular phone card.

This application claims priority to U.S. Provisional Application 61/260,015 filed on Nov. 11, 2009, the entire disclosure of which is incorporated by reference.

### TECHNICAL FIELD & BACKGROUND

Cellular phones have become very popular due to their expediency and vast array of components. However, cellular phones are not properly equipped to accommodate disabled persons. To access various applications, such as text messaging, one must be able to see the cellular phone and use their hands. There are many people with limited mobility or are sensory impaired. Currently, cellular phones do not allow a person to access all of their cell phones components using their voice. This limits the cellular phone usage of some individuals and a more efficient alternative to these phones is needed.

The present invention generally relates to a cellular phone memory card. More specifically, the invention is an enhanced cellular phone memory card with a voice activated component.

It is an object of the invention to provide an enhanced cellular phone memory card with a voice activated component that will enable a user to access their phone's applications and components using voice commands.

It is an object of the invention to provide an enhanced cellular phone memory card with a voice activated component that can be used by anyone with a cellular phone, but is especially ideal for disabled persons, who may have trouble using a standard cellular phone.

It is an object of the invention to provide an enhanced cellular phone memory card with a voice activated component that can allow users to send and receive text messages, look up words in the dictionary, learn a new language, or send commands to their television or gaming system.

It is an object of the invention to provide an enhanced cellular phone memory card with a voice activated component that allows individuals to have full access to their cellular phone using only their voice.

What is really needed is an enhanced cellular phone memory card with a voice activated component that will enable a user to access their cellular phone's applications and components using voice commands, that can be used by anyone with a cellular phone, but is especially ideal for disabled persons, who may have trouble using a cellular phone, that can allow a user to send and receive text messages, look up words in the dictionary, learn a new language, or send commands to a television or gaming system and that allows the user to have full access to their cellular phone using only their voice.

### BRIEF DESCRIPTION OF THE DRAWINGS

The present invention will be described by way of exemplary embodiments, but not limitations, illustrated in the accompanying drawings in which like references denote similar elements, and in which:

FIG. 1 is an overhead perspective view of an enhanced cellular phone memory card with a voice activated component, in accordance with one embodiment of the present invention.

FIG. 2 is a block diagram showing an enhanced cellular phone memory card with a voice activated component card, in accordance with one embodiment of the present invention.

FIG. 3 is a diagram showing an enhanced cellular phone memory card with a voice activated component card in communication with a television, radio, Internet, or gaming system, in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known components are omitted or simplified in order not to obscure the illustrative embodiments.

Various operations will be described as multiple discrete operations, in turn, in a manner that is most helpful in understanding the present invention, however, the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise.

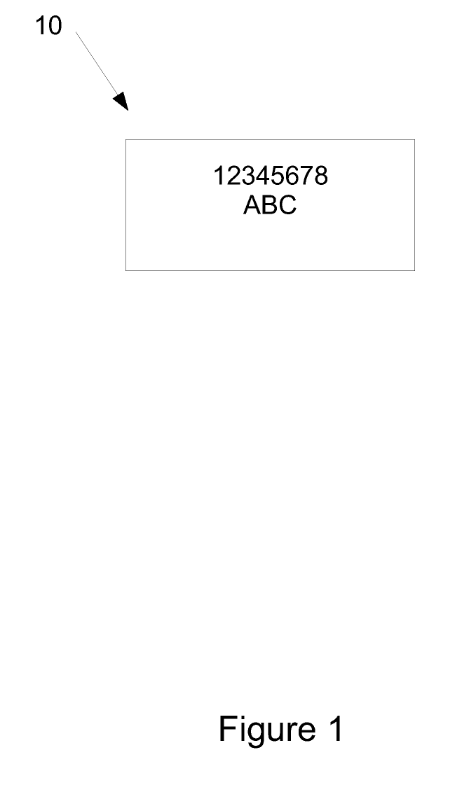

FIG. 1 is an overhead perspective view of an enhanced cellular phone memory card 10 with a voice activated component 20, in accordance with one embodiment of the present invention. The enhanced cellular phone memory card 10 with a voice activated component 20 is an enhanced memory card for cellular phones that will allow the user to access and use components of their cellular phone 30 using their voice. The voice activated component 20 can receive a user's voice instructions and perform those instructions on a cellular phone 30 that is attached to the enhanced cellular phone memory card 10. Voice activated technology utilized by the voice activated component 20 is also well known in the art. A cellular phone 30 is defined as any cell phone, Smartphone™, web enabled phone, camera phone, personal digital assistant (PDA) cell phone, digital phone, analog phone and other types of cellular phones that are well known in the art. The enhanced cellular phone memory card 10 with a voice activated component 20 affords the user several advantages not available with existing cellular phones 30. The enhanced cellular phone memory card 10 with a voice activated component 20 can be programmed to allow the user to send and receive text messages simply by using voice commands. E-mails may also be composed by using the enhanced cellular phone memory card 10 with a voice activated component 20 as the user can use their voice to communicate what needs to be written and sent by the cellular phone 30.

The enhanced cellular phone memory card 10 with a voice activated component 20 can assist the user in saving numbers and names using voice commands, as well as making and receiving phone calls. The enhanced cellular phone memory card 10 with a voice activated component 20 may also provide a dictionary application, which allows the user to request the spelling and definition of a word. The dictionary application may also provide an example of a sentence using the requested word. All of this information can be relayed back to the user audibly and visually. There may also be an option for the user to purchase different memory cards, which are all programmed for a specific subject, such as math, anatomy, and other subjects well known in the art. The enhanced cellular phone memory card 10 will allow the user to study using their cellular phone 30. The enhanced cellular phone memory card 10 with a voice activated component 20 may be available in a variety of languages that are well known in the art.

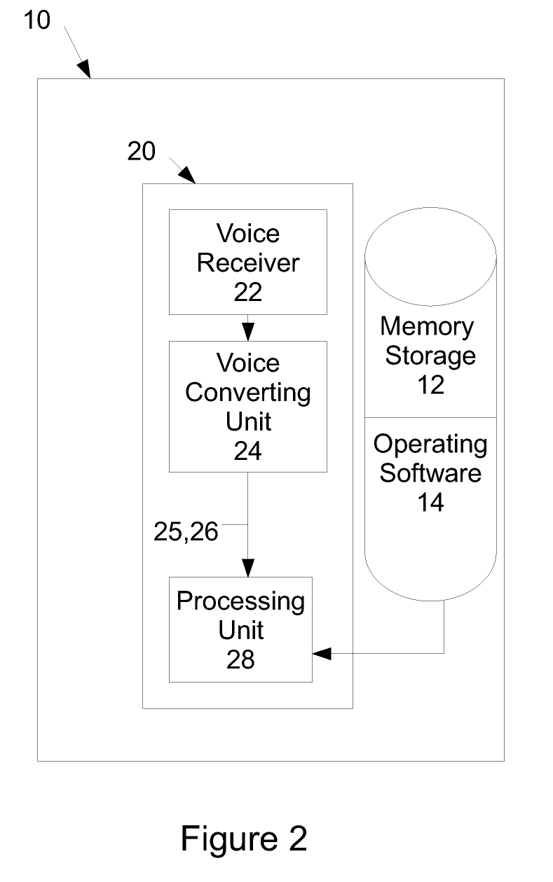

FIG. 2 is a block diagram showing an enhanced cellular phone memory card 10 with a voice activated component 20, in accordance with one embodiment of the present invention. The voice activated component 20 of the enhanced cellular phone memory card 10 has a voice receiver 22 to receive any voice instructions or commands from a user and a voice converting unit 24 to convert the voice commands into an electronic signal 25 that can be transmitted through a bus 26 to a processing unit 28. The voice receiver 22 and voice converting unit 24 are all well known in the art and the processing unit 28 can be any microchip or microprocessor (not shown) that is well known in the art that can process and perform the instructions for the enhanced cellular phone memory card 10. The enhanced cellular phone memory card 10 also has standard memory storage 12 and operating software 14. The operating software 14 can include the dictionary application, an application for a specific subject, such as math and anatomy and for different languages, as previously described in the FIG. 1 description.

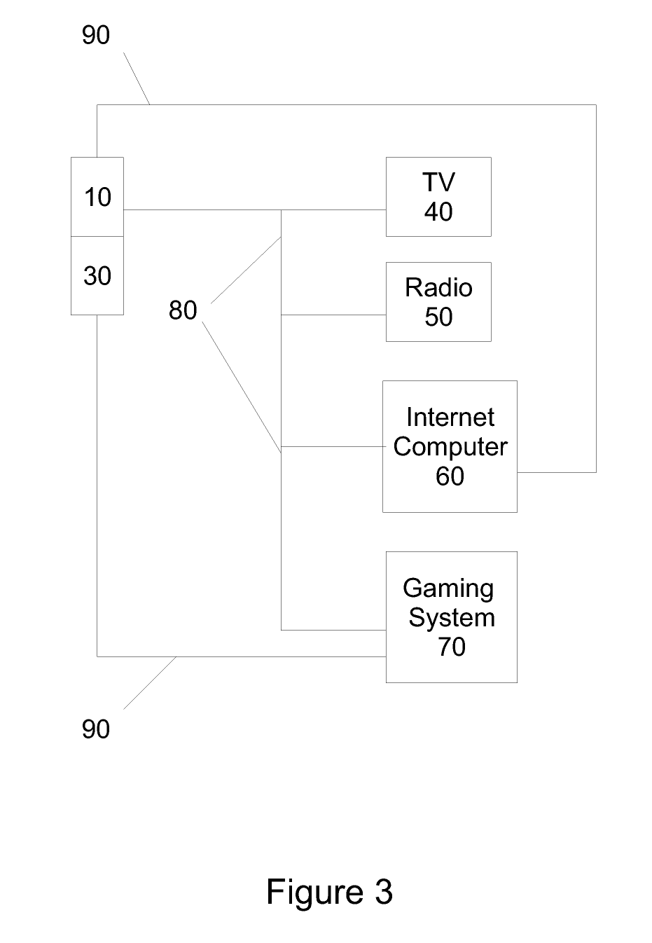

FIG. 3 is a block diagram showing an enhanced cellular phone memory card 10 with a voice activated component 20 in communication with a television 40, a radio 50, an Internet enabled computer 60 or a gaming system 70, in accordance with one embodiment of the present invention. When a USB cord 80 is attached to the cellular phone 30, it may be used to communicate with and to give voice commands to the television 40, radio 50, Internet enabled computer 60 or gaming system 70. This provides full accessibility for the disabled who may not otherwise be able to access these devices. The enhanced cellular phone memory card 10 can be available with various amounts of memory storage 12 that is well known in the art. The enhanced cellular phone memory card 10 may be inserted into any cellular phone 30 that accepts memory cards. The cellular phone 30 can also be wirelessly connected to the Internet enabled computer 60 or gaming system 70 to communicate with and to give voice commands to the television 40, radio 50, Internet enabled computer 60 or gaming system 70. Any wireless connection 90 well known in the art can be used to communicate and give these voice commands from the cellular phone 30 using the enhanced cellular phone memory card 10.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

What is claimed is:

1. A cellular phone card used in combination with a user's and a user's cellular phone, comprising:
a voice activated component that includes a voice receiver to receive said user's voice commands and instructions, a voice converting unit that receives and converts said user's voice commands and instructions into an electronic signal transmitted over a bus to a processing unit to process and execute said user's voice commands and instructions; and
memory storage with operating software to store data and run any said user's voice commands and instructions associated with said cellular phone card.

2. The cellular phone card according to claim 1, wherein said cellular phone card can be programmed to allow said user to send and receive text messages using said user's voice commands and instructions.

3. The cellular phone card according to claim 2, wherein said user's voice commands and instructions can compose and send e-mails using said cellular phone card and said user's cellular phone.

4. The cellular phone card according to claim 2, wherein said user's voice commands and instructions can save phone numbers and names.

5. The cellular phone card according to claim 2, wherein said user's voice commands can make and receive phone calls.

6. The cellular phone card according to claim 1, wherein said operating software includes a dictionary application, a specific subject application and a foreign language application.

7. The cellular phone card according to claim 6, wherein said dictionary application provides a spelling and definition of a requested word.

8. The cellular phone card according to claim 7, wherein said dictionary application provides an example of a said requested word in a sentence.

9. The cellular phone card according to claim 6, wherein said specific subject application includes math or anatomy.

10. The cellular phone card according to claim 1, wherein said cellular phone card and said cellular phone are in communication with a television, a radio, an Internet enabled computer or a gaming system.

11. The cellular phone card according to claim 10, wherein a USB cord is used to communicate with said television, said radio, said Internet enabled computer or said gaming system.

12. The cellular phone card according to claim 10, wherein a wireless connection is used to communicate with said Internet enabled computer or said gaming system.

13. The cellular phone card according to claim 11 or 12, wherein said user gives said voice commands and instructions to said television, said radio, said Internet enabled computer or said gaming system.

14. The cellular phone card according to claim 1, wherein said cellular phone is a Smartphone, a web enabled phone, a camera phone, a personal digital assistant (PDA) cell phone, a digital phone or an analog phone.

15. The cellular phone card according to claim 14, wherein said cellular phone card can be used in combination with any said cellular phone that accepts memory cards.

16. The cellular phone card according to claim 1, wherein said processing unit is a microchip or a microprocessor.
